(19) United States
(12) Patent Application Publication
(10) Pub. No.: US 2003/0095106 A1
(43) Pub. Date: May 22, 2003

(54) Push button apparatus

(76) Inventors: Shih-Chieh Wang, Taipei (TW); Chien-Lung Huang, Taipei (TW); Yen-Te Chiang, Taipei (TW); James Tseng, Shulin City (TW); Chu-Yang Hsu, Hsinchu (TW); Hsi-Hsing Hsu, Shinshing Tsuen (TW)

Correspondence Address: BRUCE H. TROXELL, SUITE 1404, 5205 LEESBURG PIKE, FALLS CHURCH, VA, 22041, US

(21) Appl. No.: 10/075,287

(22) Filed: Feb. 15, 2002

(30) Foreign Application Priority Data
Nov. 22, 2001 (TW) 90220196

(51) Int. Cl. G09G 5/00

(52) U.S. Cl. 345/168

(57) ABSTRACT

A push button apparatus includes a micro switch, an interface structure located on the micro switch, a push button top cap and a compression spring located between the interface structure and the push button top cap. The push button top cap has a bottom surface which has a protrusive hub located thereunder for housing a top section of the interface structure. The top section of the interface structure is hollow and includes at least one pair of independent and opposing elastic upper arms extending therefrom. Each upper arm has an outer surface that has a retaining jut formed thereon. The protrusive hub has a receiving opening of a selected height formed at a respective location corresponding to the retaining jut to form a restrictive sliding relationship in between and thereby allows the push button top cap sliding in the top section of the interface structure.

### FIELD OF THE INVENTION

The present invention relates to a push button apparatus and more particularly to an improved apparatus that can increase the durability of the apparatus by altering the forcing patent among components.

### BACKGROUND OF THE INVENTION

Directional or non-directional push buttons are widely used in computers, Personal Digital Assistant (PDA), or the like index Input Devices of electronic products or equipments. In the art, the push button apparatus can be variously constructed; in particular, FIG. 1 shows one of those constructions.

Referring to FIG. 1, a conventional push button apparatus as shown mainly consists of a micro switch 5, an interface structure 4, a compression spring 6 and a push button top cap 3. The micro switch 5 is located on a base plate 2 of an electronic device and provides a strut 51 located thereon to receive application forcing. The strut 51 is housed in a lower installation space 43 of the interface structure 4 that further provides an upper installation space 41 and a middle indented retain ring 42. The push button cap 3 is exposed outside to the casing 1 of the electronic device. The push button 3 further has a bottom surface 30 which has a pawl structure 31 extended thereunder. The pawl structure 31 includes a plurality of separate fingers extending downwards and having individual inward pointing latch tip 311 formed at the bottom end of each finger. The pawl structure 31 forms an inner stroke space 32 for housing the top section (including the upper installation space 41) of the interface structure 4. As shown, when the pawl structure 31 engages with the interface structure 4, the latch tip 311 is snapped into the indented retain ring 42 which presents a selected height, and the compression spring 6 is housed in the upper installation space 41 and allows its top end to be depressed by the bottom surface 30 of the push button top cap 3. Through resilience provided by the compression spring 6 and sliding mobility provided by the latch tip 311 in the indented retain ring 42, the conventional push button apparatus can then proceed a return function after a compression (with a maximum compression displacement designated “s” as shown).

It is known in the art that the service lifetime of an apparatus as a whole is equal to the lifetime of the weakest or the critical element. In the apparatus shown in FIG. 1, it is easy to see that the weakest element is the push button top cap 3 having the pawl structure 31. In particular, the most likely destructive spot of the cap 3 is the root or conjunction section of the fingers of the pawl structure 31. While the apparatus of FIG. 1 under operation, a user can exert forcing to depress or move the upper end of the push button top cap 3 and, through linkage relationship as shown, to indirectly act upon the micro switch 5. During the forcing, each finger of the pawl structure 31 is acted as a suspending beam extending from the bottom surface 30 of the push button top cap 3 by which an allowance for flexibility can be provided to the apparatus.

FIG. 2 shows one of the forced fingers of the pawl structure 31 rooted to the push button top cap 3. When an external force moves the push button top cap 3, the finger at a particular side of the pawl structure 31 has an inner wall 310 to receive a normal force F from the interface structure 4. As a result, the pawl structure 31 can generate a substantial deformation (shown by broken lines in the drawing). Based on the geometrical relationship of the cap 3 and the fracture mechanics, the inner root section A of the pawl structure 31 (generally made of plastics having a relatively brittle property) is usually the weakest spot in terms of strength (i.e. the concentration point of the stress), which is the most likely destructive spot (note: according to destructive theory, the destruction of a brittle material is mainly caused by tensile stress). Hence, under such a forcing pattern, the inner side root section A of the pawl structure 31 is the most likely destructive spot of the whole apparatus. This can be further proved by experiences in the field that a fracture is always occurred at the finger root of the pawl structure 31.

Moreover, while in assembling the apparatus shown in FIG. 1, for the dimensions of elements are all relatively small, it is highly possible that workers might negligently bend the finger excessively during engaging the interface structure 4 into the stroke space 32 of the pawl structure 31 and thereby that micro cracks are usually initiated in the inner root section A after the installation is completed. Thereafter, those micro cracks tend to grow and might be enlarged rapidly under the repeatedly compression and movement when the apparatus is in use. Upon such a construction of the conventional push button apparatus, it can be foreseen that a satisfactory durability of the apparatus cannot be expected due to the weak pawl structure 31.

### SUMMARY OF THE INVENTION

The primary object of the invention is to provide a push button apparatus that has improved structural elements to achieve a favor forcing pattern so as to increase the durability of the whole apparatus and thus to reduce the operation cost of the apparatus.

The push button apparatus of the invention is adapted for use in an index input device of electronic products, and includes a micro switch, an interface structure, a push button top cap and a compression spring.

The micro switch is located on a baseboard of an electronic product.

The interface structure located above the micro switch further includes a hollow top section that has at least one pair of independent and opposing elastic upper arms, in which each upper arm has an outer wall with a retaining jut formed thereon.

The push button top cap of the present invention has a bottom surface and a protrusive hub extending from the bottom surface. The protrusive hub for forming a housing chamber to receive the top section of the interface structure further includes a plurality of receiving opening with a predetermined height formed at appropriate locations corresponding to the retaining juts.

The compression spring is located between the top section of the interface structure and the bottom surface of the push button top cap so as to provide restoring force while in operation of the push button top cap.

In the invention, when the top section of the interface structure is held in the housing chamber of the protrusive hub, the retaining jut of the upper arm engages with the respective receiving opening of the protrusive hub for allowing the push button top cap to form a restrictive sliding relationship with the interface structure and thereby allow the push button top cap to slide limitedly along the interface structure.

In the invention, the cross sections of the interface structure top section and the interior contour of the protrusive hub (say, a cross section pair) are preferably formed in a complementary fashion. For instance, in one embodiment, the cross section pair may be a square pair, and in another embodiment, the cross section may be a circle pair. Of course, the cross section pair may also be made in any other forms desired.

In the invention, the top section of the interface structure may have a sliding guide arm located between two adjacent upper arms to aid smooth and steady sliding movement of the top section in the protrusive hub.

In the invention, the upper arms of the interface structure may also be formed in a graduation manner to balance the operation of the push button top cap.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 a cross-sectional view of a conventional push button apparatus;

FIG. 2 is a fragmentary schematic view of a pawl structure of FIG. 1 under forcing;

FIG. 3 is an exploded view of a preferred embodiment in accordance with the present invention;

FIG. 4 is a cross-sectional view of FIG. 3;

FIG. 5 is a schematic view of the interface structure of FIG. 3 under forcing; and

FIG. 6 is a perspective view of another embodiment of the interface structure and the push button top cap in accordance with the present invention.

### DESCRIPTION OF THE PREFERRED EMBODIMENTS

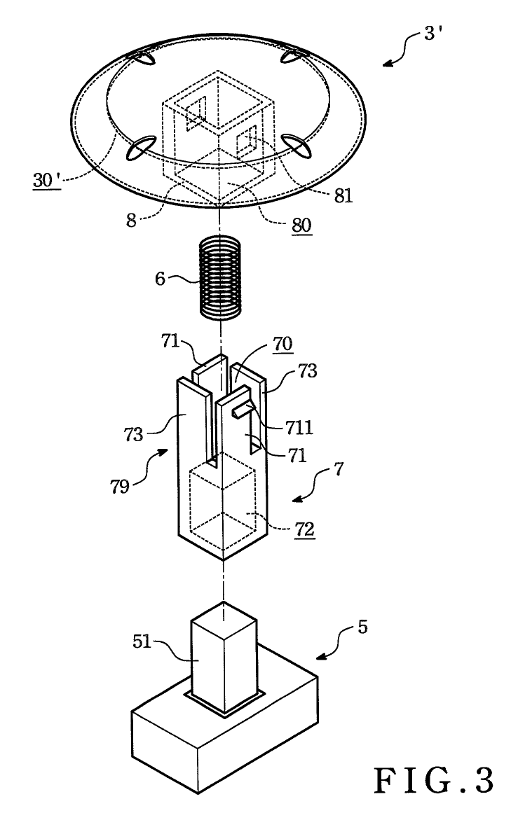

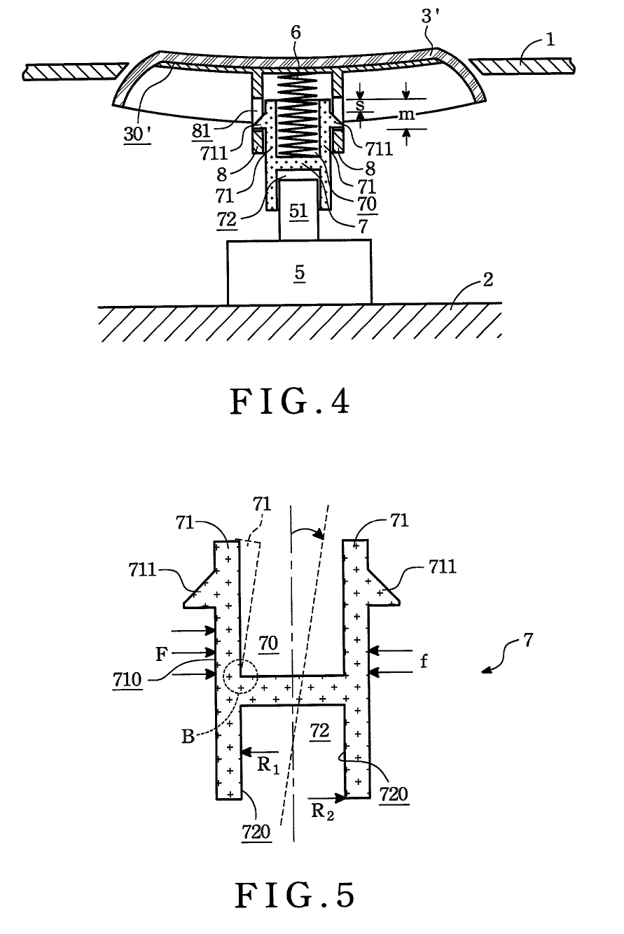

Referring now to FIGS. 3 and 4 for a preferred embodiment of the invention, the push button apparatus of the invention is adapted for use in an index input device for electronic products, and can include a micro switch 5, an interface structure 7, a push button top cap 3′ and a compression spring 6.

The micro switch 5 is known in the art and is located on a baseboard 2 of an electronic product.

The interface structure 7 provides a lower installation space 72 to couple with a strut 51 of the micro switch 5 and a hollow top section 79 which has at least one pair of independent and opposing elastic upper arms 71 (a pair, shown in the drawings) extending upwards. Each of the upper arms 71 has an exterior surface which includes a retaining jut 711 located thereon to form a sliding engagement with the push button top cap 3′. As shown, the opposing elastic upper arms 71 form an upper installation space 70 in the top section 79 to accommodate the compression spring 6.

The push button top cap 3′ has a bottom surface 30′ and a protrusive hub 8 extending from the bottom surface 30′. The protrusive hub 8 forms a housing chamber 80 to receive the top section 79 of the interface structure 7. The protrusive hub 8 further has a receiving opening 81 of a selected height “m” formed at a appropriate location corresponding to the retaining jut 711 of the interface structure 7. The selected height “m” is designed so as to provide a relative sliding allowance between the interface structure 7 and the push button top cap 3′. As shown in FIG. 3, it is noted that the selected height “m” is greater than the stroke length “s” of the interface structure 7 in the protrusive hub 8.

The compression spring 6 is located in the upper installation space 70 of the interface structure 7 and has a top end for pressing the bottom surface 30′ of the push button top cap 3′ thereby to provide a restoring force after compression operation of the push button top cap 3′.

Referring to FIG. 4, after the top section 79 of the interface structure 7 is held in the housing chamber 80 of the protrusive hub 8, the retaining jut 711 of the upper arm 71 engages with the receiving opening 81 so that the push button top cap 3′ can be slidable (at a stroke “s”) with respect to the interface structure 7 within the selected height “m”.

In the invention, the dimension of the receiving opening 81 is greater than the retaining jut 711 so as to provide the retaining jut 711 a spatial allowance while moving in the receiving opening 81. Upon such an arrangement, the upper arm 71 can be operated eccentrically in various directions.

Comparing with the conventional techniques, the present invention provides a protrusive hub 8 to replace the pawl structure at the push button top cap. Regarding the elastic arm structure, the upper arms 71 of the interface structure 7 are applied to substitute the fingers in the pawl structure described above. Such a replacement of the present invention has obviously and successfully assigned the interface structure 7 as the critical element of lifetime for the push button apparatus.

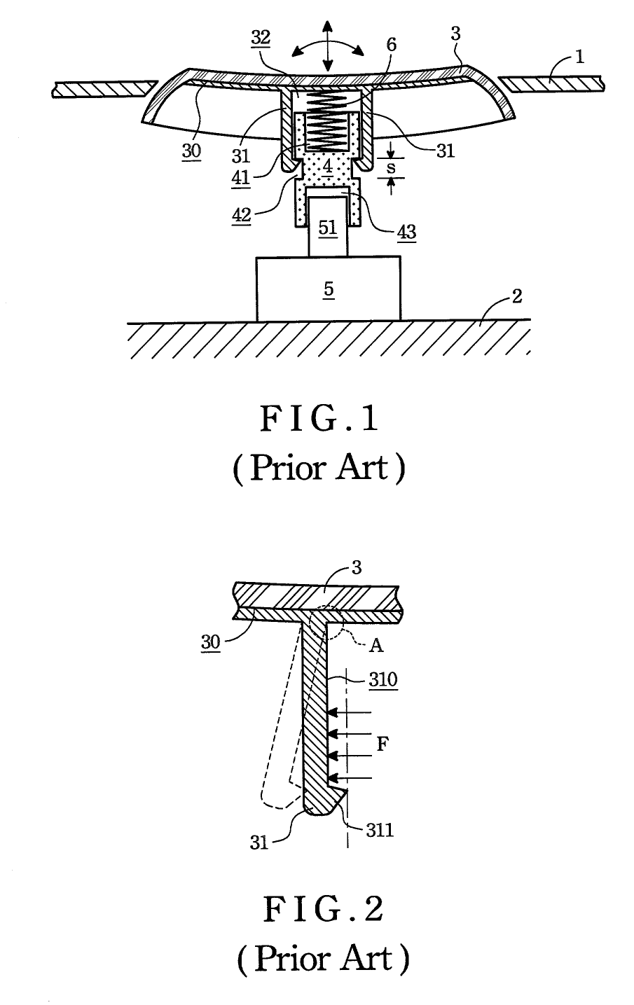

Referring now to FIG. 5, an analysis upon the interface structure 7 under forcing is illustrated (as far as destructive mechanics is concern, the bending resulted from the forcing is most likely to cause damage on an elastic arm). Due to movement of the protrusive hub 8, the force-receiving surface 710 on the exterior side of the upper arm 71 can receive a force F that causes the interface structure 7 to tilt sideward and incur a reaction force. The reaction force includes a resistant force f incurred to a lower rim of the receiving opening 81 on the protrusive hub 8 that contacts the upper arm 71 at another side, and contact forces R1 and R2 incurred between the lower installation space 72 of the interface structure 7 and the strut 51 of the micro switch 5. Apparently, the most likely destructive spot of the upper arm 71 is at the root section B. Based on elasticity and fracture mechanics, a compression force for the root section B is less destructive for plastic material than a tensile stress is (as shown in FIG. 2). Hence, according to the mechanics consideration, the whole apparatus of the present invention can provide a longer service lifetime than one structured by conventional techniques (as shown in FIG. 1).

Furthermore, while manufacturing, the push button top cap has to go through a metal coating or plating process for the top surface, and thus has a higher production cost than the interface structure (made of plastics with die casting or injection). Hence, except for the concern of lifetime of the apparatus, the combination of the invention also has a lower replacement or maintenance cost than the conventional apparatus.

In the embodiment of FIG. 3, the top section 79 of the interface structure 7 may further include at least one sliding guide arm 73 (a pair of sliding guide arms 73 are shown in the drawing). Each sliding guide arm 73 is located between two adjacent upper arms 71 and can serve the function of enhancing the slide of the top section 79 with respect to the protrusive hub 8. In addition, when the interface structure 7 subjects to a side force, the force can be also shared by the sliding guide arm 73 through the contacting with the inner sidewalls of the protrusive hub 8. Thus, the action forces exerting on the upper arms 71 may be further reduced so that the lifetime of the upper arms 71 can be increased.

In the invention, the upper arms 71 of the interface structure 7 may be configured in a graduation manner (such as a 180-degree separation shown in FIG. 3) to balance the forcing from the push button top cap 3′.

In the invention, the cross sections of the top section 79 of the interface structure 7 and the inner contour of the protrusive hub 8 are preferably made to be complementary with each other. For instance, the embodiment shown in FIG. 3 utilizes a complementary cross section pair of a square. Of course, other cross section pairs may be selected as well.

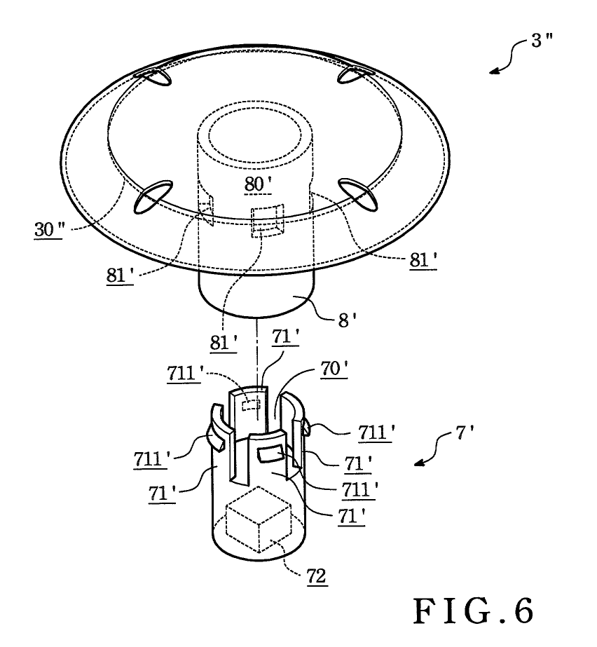

Referring now to FIG. 6, another embodiment for the interface structure and push button top cap of the invention is shown. The cross section pair of the top section 79′ of the interface structure 7′ and the inner contour of the protrusive hub 8′ are formed in complementary circles. The top section 79′ of the interface structure 7′ has two pairs of upper arms 71′ angularly spaced from one another in a 90-degree graduation. Respectively, the protrusive hub 8 also have four corresponding receiving openings 81′.

In the present invention, the matching or coupling of the retaining juts and receiving openings may also be implemented by other suitable means; such as one having the retaining juts disposed on the protrusive hub and the receiving openings located on the upper arms, one adopting other retaining and sliding means known in the art, and so on. Such a change is an equal effect transformation familiar to those skilled in the art, and thus will be omitted herein.

In the invention, through the improvement upon the push button top cap and the interface structure, the stress pattern at the maximum stress spot of the critical element of the push button apparatus can be favorably transferred to become a compression region, from a destructive tensile region in the prior art. Hence, the service lifetime of the whole apparatus can be increased. Moreover, the shift of the critical element from the push button top cap in the prior art to the interface structure in the present invention is also contributed to decrease the maintenance cost of the apparatus.

While the preferred embodiments of the inventions have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A push button apparatus, comprising a micro switch located on a baseboard, an interface structure mounted to the micro switch, a push button top cap having a bottom surface, and a compression spring located between the interface structure and the bottom surface of the push button top cap; push button top cap further including a protrusive hub extending from the bottom surface for housings top section of the interface structure; characterized in that: the top section is hollow and includes at least one pair of independent and opposing upper arms extending upwards, each of the upper arms having an exterior surface which has a retaining jut formed thereon, the protrusive hub having a receiving opening of a selected height formed at a location corresponding to the respective retaining jut so as to have the retaining jut be restrictively slidable in the receiving opening for allowing the push button top cap to slide with respect to the top section of the interface structure while the top section engaging with the protrusive hub.

2. The push button apparatus of claim 1, wherein the interface structure has a cross section complementary with an inner contour cross section of the protrusive hub.

3. The push button apparatus of claim 2, wherein the cross section is a square.

4. The push button apparatus of claim 2, wherein the cross section is a circle.

5. The push button apparatus of claim 1, wherein the top section of the interface structure includes at least a sliding guide arm located between the upper arms to enhance the top section sliding steadily with respect to the protrusive hub.

6. A push button apparatus located on a base board, comprising:
a micro switch, located on the baseboard;
an interface structure, mounted to the micro switch, having at least one pair of independent and opposing elastic upper arms extending from a peripheral contour thereof, each of the upper arms having an outside surface which has a retaining jut formed thereon;
a push button top cap, having a bottom surface and a protrusive hub extending from the bottom surface for housing the upper arms of the interface structure, the protrusive hub having a receiving opening of a selected height formed at a location corresponding to the respective retaining jut; and
a compression spring, located between the interface structure and the bottom surface of the push button top cap;
wherein, when the upper arms of the interface structure engages with the protrusive hub, the retaining jut is restrictively slidable in the receiving opening to allow the push button top cap sliding with respect to the interface structure.

7. The push button apparatus of claim 6, wherein the interface structure has a sliding guide arm located between the upper arms to enhance the top section sliding steadily with respect to the protrusive hub.

8. The push button apparatus of claim 6, wherein the upper arms are formed on the interface structure in a graduation fashion.
